(19) United States
(12) Patent Application Publication
(10) Pub. No.: US 2017/0132565 A1
(43) Pub. Date: May 11, 2017

(54) REUSABLE PARCEL APPARATUS AND METHODS

(71) Applicant: ROBERT DALE BEADLES, LODI, CA (US)

(72) Inventors: Robert Dale BEADLES, Lodi, CA (US); Nicole Georgette BEADLES, Lodi, CA (US)

(73) Assignee: ROBERT DALE BEADLES, LODI, CA (US)

(21) Appl. No.: 15/314,508

(22) PCT Filed: May 24, 2015
(86) PCT No.: PCT/US2015/032331

§ 371 Date: Nov. 29, 2016

Related U.S. Application Data
(60) Provisional application No. 62/002,849, filed on May 24, 2014.

(51) Int. Cl. G06Q 10/08; G06K 19/077; G06K 19/06; G06K 19/07; G06K 7/10; G06K 7/14

(52) U.S. Cl. CPC G06Q 10/0838; G06K 7/10297; G06K 7/1413; G06K 7/1417; G06K 19/06028; G06K 19/06037; G06K 19/0723; G06K 19/07758; G06Q 2250/30; G06K 2019/06253

(57) ABSTRACT

An apparatus and method for reusable parcels (701,1104,1200) are provided herein. In one embodiment, a method includes receiving a request to activate a scannable parcel tag (410,36-38, 1202) having a logical link associated therewith, receiving parcel information for the scannable parcel tag (410,36-38, 1202), the parcel information having at least shipping data, storing in a database record, the parcel information, and associating the scannable parcel tag (410,36-38, 1202) with the parcel information.

### CROSS REFERENCE TO RELATED APPLICATIONS

This application claims the priority benefit of U.S. Provisional Application Ser. No. 62/002,849, filed on May 24, 2014, which is hereby incorporated by reference herein in its entirety including all references and appendices cited therein.

### BACKGROUND

1. Technical Field

Embodiments relate to parcels, and more particularly but not exclusively, to parcels with scannable parcel tags that can be utilized in a reusable manner by association with database records.

2. Description of Related Art

Postage is currently purchased physically on-site or via automated machines such as an automatic teller machine (ATM). Postage is most often represented as an adhesive stamp, which serves as proof of payment. There is no other benefit or utility associated with the postage stamp or mark. Obtaining and applying postage is inconvenient, inefficient, and often inaccurate.

Additionally, parcels are typically provided with an address indicative of a sender and an address that is indicative of a recipient. These addresses are often printed directly on the parcel making the parcel unsuitable for reuse.

### SUMMARY

Generally speaking, the present technology is directed to methods and processes where parcel information is electronically purchased and applied to parcels. This parcel information may be embodied in a scannable parcel tag such that the parcel is reusable. These scannable parcel tags may comprise, for example, one, two, or three dimensional representations such as a bar code, a quick response (QR) code, a watermark, an image, or any other visual object that is configured to encode data. The scannable parcel tag may also include a smart object such as passive or active radio frequency identification (RFID) tags that are affixed to the parcel. In another example, the scannable parcel tag can include a near field communication (NFC) tag.

The term “scan” will be understood to be expansive and encompass actions such as reading, capturing, processing, and interpreting of the, but in essence, the “scan” of any specific scannable parcel tag will depend on the type of tag used. For example, bar code and QR code scannable parcel tags require scanning and reading of the tag using, for example, a camera and bar code reading application. A “scan” of a near field communication object, such as an NFC tag, requires only that the reader device be within a specific proximity to the NFC tag.

In accordance with the present disclosure, a database record is created for each scannable parcel tag. This database record can include parcel information for the parcel. Many different types of parcel information can be stored in the database record. For example, in one embodiment, the parcel information includes at least a shipping address for a recipient of the parcel. In another embodiment the parcel information comprises a shipping address for a recipient and a sender address or return address. In yet another example, the parcel information comprises at least one of (or both of) a shipping address for a recipient and a sender address or return address, as well as postage information, such as an amount of postage required to ship the parcel from the sender address to the recipient address.

The database record can include postage payment information for the sender such as a credit card number (and associated transaction information such as CVV, address, and date), a checking account and routing number, and/or a deposit account that includes funds deposited by the sender. Funds may be deducted from the deposit account on an as-needed basis when the sender ships a parcel.

This record is coupled to a tag of the present technology using any logical link such as a URL, a uniform resource identifier (URI), a domain, a subdomain, a virtual subdirectory, an IP address, and so forth. The data (e.g., store credit amount) associated with the record can be embodied, for example, in a barcode, a QR code, or any other visual object that is configured to encode data. Again, the scannable postage code may include devices that are configured to emit or communicate information such as RFID and NFC tags.

The scannable parcel tags can be scanned by point-of-sale systems and mobile devices that are configured to scan postage codes of the present technology.

The present technology allows consumers to pay for postage digitally, allowing them the convenience of foregoing a trip to the local post office while also providing the postal service with instant revenue that is not dependent on office hours and employee assistance. The integration of delivery and tracking info in the same code also improves efficiency, accuracy, and customer satisfaction.

In some embodiments, the scannable parcel tags of the present technology can be pre-printed codes that are displayed on or affixed to parcels such as envelopes, boxes, and the like. The scannable parcel tag may also take the place of a traditional stamp. The scannable parcel tag may have any format such as one, two, or three dimensional. The scannable parcel tag is digitally embedded with a pre-existing logical link such as a uniform resource locator (URL) or uniform resource indicator (URI), just as examples. Other logical links such as a domain, a subdomain, a virtual subdirectory, an IP address, and so forth may also likewise be utilized in accordance with the present technology.

In general, the scannable parcel tags of the present technology may be embodied in a variety of forms such as a printed tag, a sticker, a stamp, or other printed article that can be affixed to a parcel by use of an adhesive, insertion into a sleeve, or other similar methods. In other embodiments, the scannable parcel tags may be printed directly onto the parcel

The logical link or pointer references a database profile or record that is specific to that particular tag. When scanned with an appropriate reader device, data can be added, changed, or overwritten to the tag's database record for the purpose of postage and parcel tracking.

In some embodiments, a scannable parcel tag may include attached files and multimedia that may compliment the parcel being delivered. For example, in addition to postage and delivery info, the sender could also attach a link to assembly instructions for a product shipped in the parcel. The sender may also decide to provide a digital version of a hard copy document that is mailed. For example, if a contract is being sent as a letter, a digital copy of the contract may be transmitted to one or more recipient via electronic mail. Ancillary electronic documents such as informational letters, coupons, personal identification numbers, codes, and other information may be transmitted electronically when an associated parcel is shipped. For example, if a credit card is mailed using a parcel with a scannable parcel tag, the scanning of the scannable parcel tag by the recipient when the credit card is received may cause the transmission of an email to the recipient with a code that can be used to activate the credit card.

The present technology also provides methods that allow a recipient to digitally “sign for” packages by scanning the code with a personal Smartphone or other reader device. The recipient's identity signature will be associated with their reader device. In some embodiments, correspondence can be digitally “locked” until scanned by the appropriate recipient's reader device, at which point a portable document file (PDF) file becomes accessible to the recipient, which is in accordance with the example above with regard to the transmission of a credit card activation code.

In one embodiment, a method includes receiving a request to activate a scannable parcel tag, the scannable parcel tag embedding a logical link to a database record, as well as receiving parcel information for the scannable parcel tag, the parcel information comprising at least shipping data. Also, the method may include storing in the database record, the parcel information.

In one embodiment the shipping data comprises at least one of information indicative of a shipper and information indicative of a recipient. In one embodiment a method includes receiving new parcel information for the scannable parcel tag, the new parcel information comprising at least shipping data, the new parcel information being different from the parcel information. Also, the method includes storing in the database record, the new parcel information. Again, the scannable parcel tag can be reused a plurality of times by editing or modifying the shipping information included in the database record. This change in shipping information does not require a reprinting of the scannable parcel tag onto the parcel because the scannable parcel tag includes a logical link to database record. Thus, the same parcel, with the same scannable parcel tag can be reused by editing or modifying the shipping information in the database record.

In some embodiments, a method includes receiving message that the scannable parcel tag has been scanned and transmitting to a requester the parcel information.

In another embodiment, a method includes receiving postage payment information for the scannable parcel tag and activating the scannable parcel tag for use.

Some embodiments include generating the scannable parcel tag itself. This may include printing or otherwise applying or affixing the scannable parcel tag to a parcel.

In some embodiments the method includes overwriting the at least shipping data with updated shipping data without changing the scannable parcel tag on the parcel.

In another embodiment the method includes associating a media file with the scannable parcel tag and receiving message that the scannable parcel tag has been scanned. In response to the scanning of the scannable parcel tag the media file is provided to the requester.

In one embodiment the method includes overwriting the at least shipping data with updated shipping data.

In another embodiment, a system of the present technology includes a means for receiving a request to activate a scannable parcel tag, the scannable parcel tag embedding a logical link to a database record. The system also comprises a means for receiving parcel information for the scannable parcel tag, the parcel information comprising at least shipping data. In some instances the system comprises a means for storing in a database record, the parcel information.

In another embodiment, a parcel processing system includes a processor and a memory for storing executable instructions. The processor executes the instructions to receive a request to activate a scannable parcel tag that has been applied to a parcel, the scannable parcel tag embedding a logical link to a database record. The processor further executes the instructions to receive parcel information for the scannable parcel tag, the parcel information comprising at least shipping data that identifies a recipient. Also, the processor executes the instructions to store in the database record, the parcel information.

The processor may be configured to further execute the instructions to store parcel information with the database record, the parcel information comprising any of assembly instructions, an electronic copy of content shipped in the parcel, and combinations thereof.

In some embodiments the processor further executes the instructions to lock the electronic copy of content shipped in the parcel; and unlock the electronic copy of content shipped in the parcel when the scannable parcel tag is scanned by the recipient identified in the database record.

In another embodiment the processor further executes the instructions to receive a digital signature for the parcel, the digital signature being applied by the recipient when scanning the scannable parcel tag.

In one embodiment the processor further executes the instructions to allow a sender to add, change, log, write, or overwrite the parcel information stored in the database record by scanning the scannable parcel tag.

In yet another embodiment the processor further executes the instructions to receive tracking information for the parcel each time the scannable parcel tag is scanned; and storing the tracking information in the database record.

In some embodiments the processor further executes the instructions to cause delivery of the parcel to the recipient.

In one embodiment, the present technology is directed to a method that comprises receiving an image from a wearable device, the image comprising a view of a scannable parcel tag, identifying the scannable parcel tag in the image, locating one or more users associated with the scannable parcel tag, storing location information for the wearable device in association with the scannable parcel tag, and updating tracking information for a parcel associated with the scannable parcel tag using the location information.

These and other advantages of the present technology will be described in greater detail below with reference to the collective accompanying drawings.

### BRIEF DESCRIPTION OF THE DRAWINGS

FIG. 1 is a schematic diagram of a computing architecture that can be used to practice aspects of the present technology;

FIG. 2A is a flow chart of an example method of using a scannable parcel code by a client;

FIG. 2B is a flow chart of an example method where a server presents a client 110 with an option to send a parcel;

FIG. 2C is a flow chart of an example method of parcel processing by a parcel carrier, such as the United States Post Office, or a shipping and logistics company;

FIG. 3A is a flow chart of a parcel processing method executed by a server;

FIG. 3B is a flow chart of a method for reusing the parcel with scannable parcel tag by the recipient of the method of FIG. 3A;

FIG. 4 illustrates an example system and process that implements the parcel processing of the present technology;

FIG. 5 a schematic diagram of a computing system that is used to implement embodiments according to the present technology;

FIG. 6 illustrate flexible, mobile sensor pads for use with smartphones for weighing parcels according to some embodiments; and

FIG. 7 illustrates weight-phone-sensor-blocks for transforming smart phones into scales according to some embodiments.

FIG. 8 is a schematic diagram of an example scale device, for use in accordance with the present technology according to one embodiment.

FIGS. 9 and 10 collectively illustrate perspective views of an example reusable envelope with a scannable parcel tag according to one embodiment.

FIG. 11 illustrates the capturing of an image of a scannable parcel tag using wearable technology (e.g., intelligent glasses), the transmission of GPS location information, and display of shipping information on the intelligent glasses according to one embodiment.

FIG. 12 illustrates an example method for reusing a parcel with a scannable parcel tag of the present technology, where the parcel is unchanged, using the same scannable parcel tag by a second user uploading new shipping information that allows the parcel to be mailed to a third user, according to one embodiment.

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

As mentioned above, scannable parcel tags may comprise, for example, one, two, or three dimensional representations such as a bar code, a quick response (QR) code, a watermark, an image, or any other printable representation that can be scanned by a reader device. The scannable parcel tag may also include a smart object such as a passive or active radio frequency identification (RFID) tag that is affixed to the parcel. The term “scan” will be understood to be expansive and encompass actions such as reading and capturing, but in essence the scanning of a scannable parcel tag relates more specifically to the type of scannable parcel tag use on a parcel. For example, a scannable parcel tag in the form of a OR code would be scanned by a reader device using an I/O device such as a camera that receives a view of the QR code. Image processing software executed on the reader device is used to interpret or read the information embedded into the QR code. In another example, the scannable parcel tag is a passive RFID tag that can be scanned and read using a reader device that is configured to communicate with passive RFID tags. In yet another example, the scannable parcel tag is an image that is watermarked or bears embedded information. The reader device may use an I/O device such as a camera that receives a view of the image and processes the image to extract the embedded information. In these embodiments, the scannable parcel tag can have an aesthetic appearance that is similar to a traditional postage stamp.

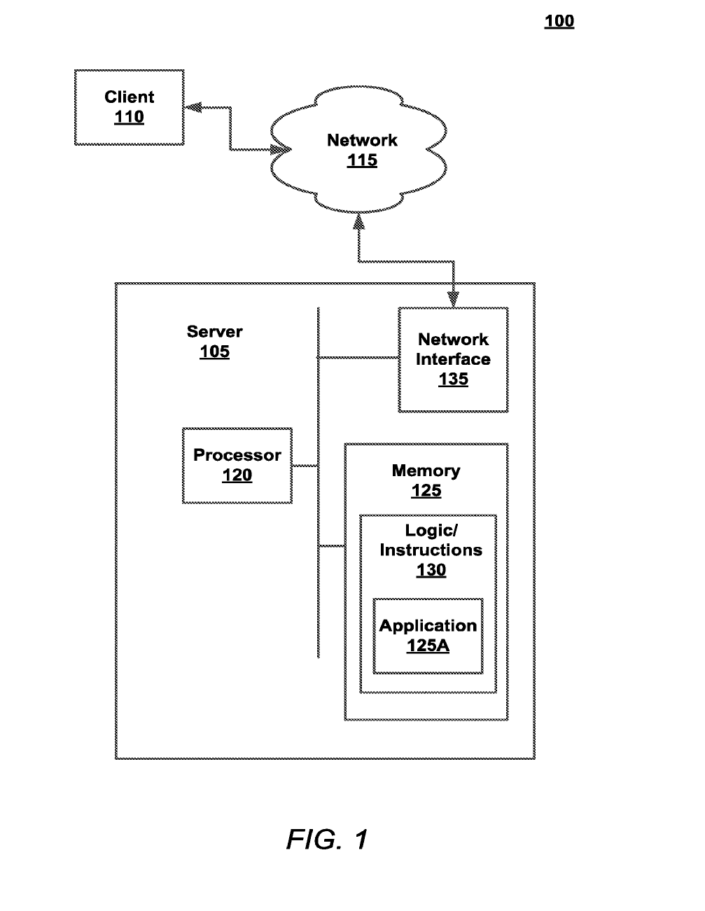

FIG. 1 illustrates an exemplary architecture 100 for a parcel tagging and processing application. The architecture 100 may include a parcel processing system (hereinafter “server 105”) that facilitates the deployment of parcel processing methods of the present technology. Users may access the server 105 and the parcel tagging and processing application 125A using a client 110 over a network 115. The client 110 may include, for example, a mobile computing device such as a tablet or a Smartphone, or a laptop or desktop computer.

According to some embodiments, the system 105 may include a cloud based computing environment. In general, a cloud-based computing environment is a resource that typically combines the computational power of a large grouping of processors and/or that combines the storage capacity of a large grouping of computer memories or storage devices. For example, systems that provide a cloud resource may be utilized exclusively by their owners, such as Google™ or Yahoo!™; or such systems may be accessible to outside users who deploy applications within the computing infrastructure to obtain the benefit of large computational or storage resources.

The cloud may be formed, for example, by a network of web servers such as server 105 with each web server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

The server 105 may communicatively couple with the client 110 via a public or private network, such as network 115. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 115 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The server 105 may couple to the network 115 using a network interface 135.

In general, the server 105 may be generally described as a particular purpose computing environment that includes executable instructions that are configured to provide the parcel tagging, processing, shipping, and/or tracking features, all of which will be described in greater detail herein. Likewise, the client 110 (also referred to as a reader device), may be generally described as a particular purpose computing environment that includes executable instructions that are configured to provide one or more of the parcel tagging, processing, shipping, and/or tracking features described herein.

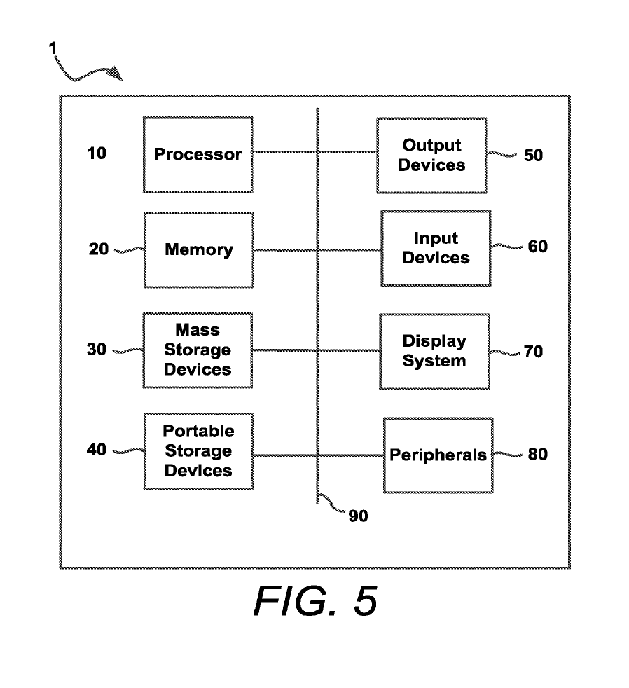

The server 105 generally comprises a processor 120 and a memory 125. According to some embodiments, the memory 125 comprises logic 130 (e.g., instructions or applications) that can be executed by the processor 120 to perform various methods. A parcel tagging and processing application 125A (hereinafter application 125A) may be stored in the memory 125 and executed by the processor 120. Additional components of the server 105 and/or client 110 are described in greater detail below with reference to the computing system 1 of FIG. 5.

It is noteworthy that the memory may include additional applications, layers, modules, engines, or components, and still fall within the scope of the present technology. As used herein, any of the aforementioned logical components may also be embodied as an application-specific integrated circuit (“ASIC”), an electronic circuit, a processor (shared, dedicated, or group) that executes one or more software or firmware programs, a combinational logic circuit, and/or other suitable components that provide the described functionality.

It will be understood that the functionalities described herein, which are attributed to the server 105 executing application 125A, may also be executed within the client 110. That is, the client 110 may be programmed to execute the functionalities and methods described herein, by executing a mobile version of the application 125A. In other instances, the server 105 and client 110 may cooperate to provide the functionalities described herein, such that the client 110 is provided with a client-side application that interacts with the server 105 such that the server 105 and client 110 operate in a client/server relationship. Complex computational features may be executed by the server 105, while simple operations that require fewer computational resources may be executed by the client 110, such as data gathering and data display. For example, scannable parcel tags of the present technology may be scanned by the client 110, while reading or extraction of information embedded into the scannable parcel tags, such as the logical link, may occur at the server 105.

Thus, in some embodiments, the mobile version of the application 125A comprises a reader application that is configured to read or scan a scannable parcel tag. The client reader application version may also be configured to extract or otherwise obtain information, such as the logical link or parcel information that is embedded into the scannable parcel tag.

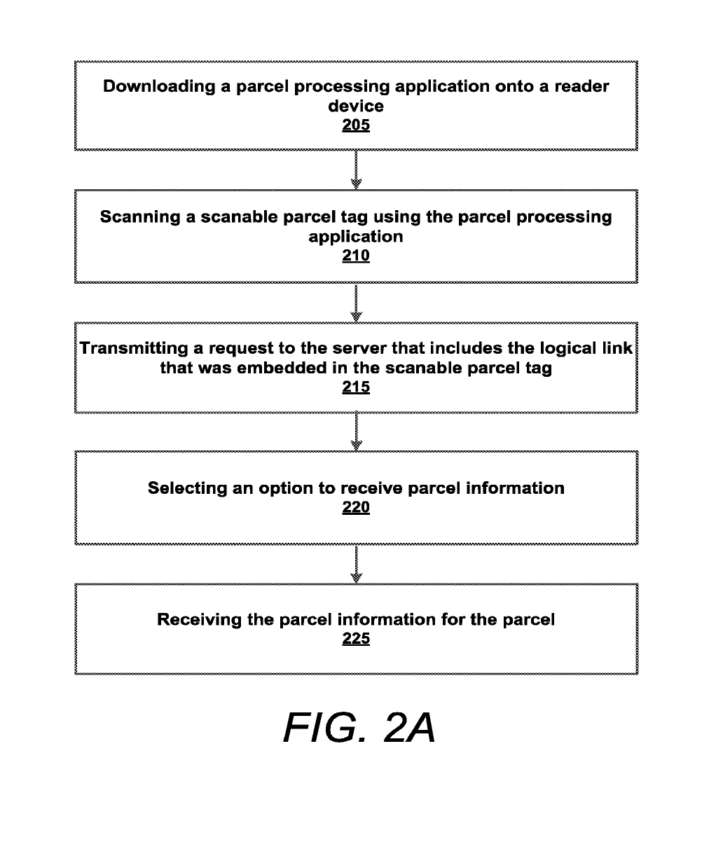

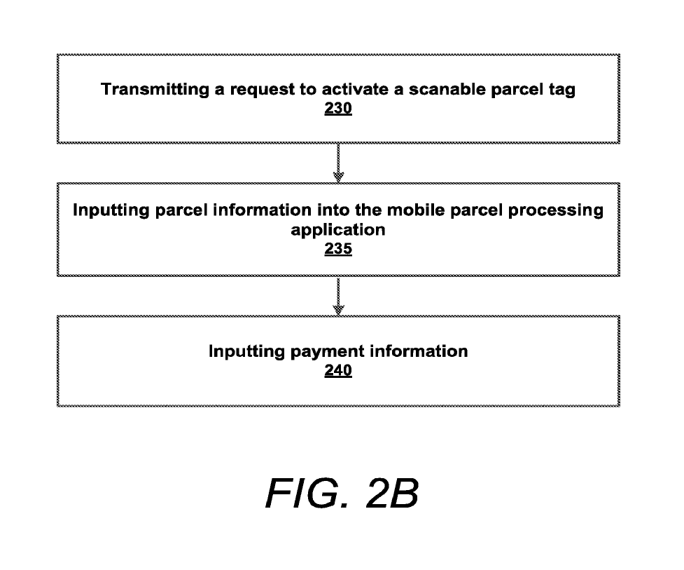

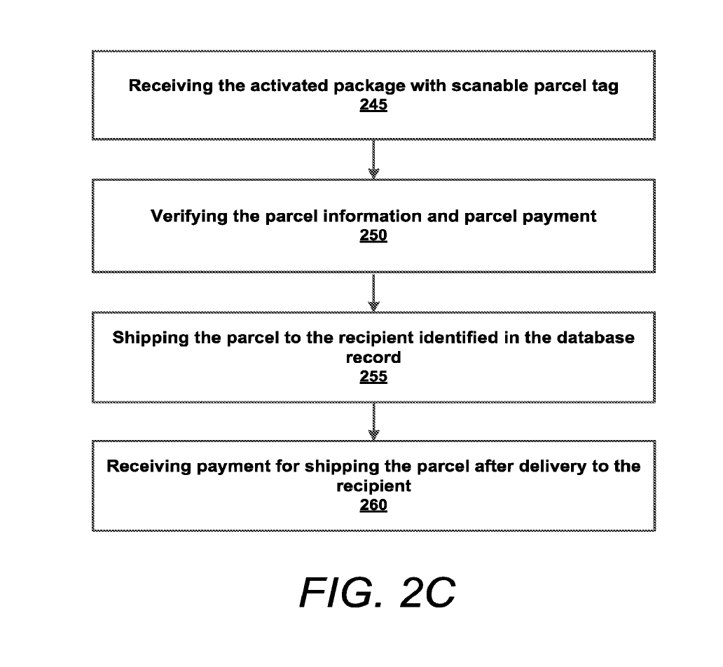

Turning now to FIG. 2A, a flow chart of an example method of parcel processing, executed by the client 110, is illustrated. The method may include a user downloading 205 a parcel processing application onto their reader device. For example, the user may utilize their Smartphone to download a parcel processing application from the server 105. In some embodiments the user can create a user profile and obtain authentication credentials.

The user may activate a parcel with a scannable parcel tag by scanning 210 a scannable parcel tag using the parcel processing application. The method further includes the mobile parcel processing application extracting a logical link that was embedded into the scannable parcel tag.

After extraction of the logical link, the method further includes transmitting 215 by the client 110 a request to the server 105 that includes the logical link that was embedded in the scannable parcel tag. The server 105 may present the client with an option selection step such as an option to receive parcel information for the parcel. The method may include the sender selecting 220 an option to receive parcel information as well as a step of receiving 225 the parcel information for the parcel. Parcel information can include information indicative of a sender, a recipient, tracking information for other entities that have scanned the scannable parcel tag, funds or payment information, tracking numbers, tracking status, as well as other parcel or shipping related information that would be known to one of ordinary skill in the art.

It will be understood that in some embodiments, a request for the parcel information is not required, such that the server 105 automatically transmits parcel information to a reader device when the scannable parcel tag is read.

FIG. 2B illustrates another optional method where the server 105 presents the client 110 with an option to send a parcel in the option selection step as mentioned above. If this option is selected, the method includes transmitting 230 to the server 105 a request to activate a scannable parcel tag. The request may include the logical link that was determined from the scanning of the scannable parcel tag. Again, as mentioned above, the client 110 may alternatively capture an image of the scannable parcel tag using, for example, a native client camera and transmit the image to the server 105. The server 105 can extract the logical link without requiring the mobile parcel processing application to read the scannable parcel tag.

If the scannable parcel tag has never been used before, the server 105 may create a database record for the scannable parcel tag. If a database record has already been created for the scannable parcel tag the scannable parcel tag may verify that the scannable parcel tag is ready for use. If the scannable parcel tag is available for use the server 105 may indicate to the client 110 that the server 105 is ready to receive parcel information for the scannable parcel tag.

Thus, the method includes inputting 235 parcel information into the mobile parcel processing application, typically by way of a graphical user interface. It will be understood that the mobile parcel processing application may generate a plurality of different graphical user interfaces that allow the user to interact with the functionalities of the mobile parcel processing application such as data input and display, all of which would be apparent to one of ordinary skill in the art.

If the scannable parcel tag has been used before it may be necessary to overwrite parcel information into the database record. For example, if the parcel has been used previously and sent to a first recipient, the parcel information indicative of the first recipient may be overwritten if the parcel is being sent to a second recipient with different shipping information than the first recipient. Thus, the parcel having the scannable parcel tag can be reused by overwriting the parcel information stored in the database record.

The recipient information can be obtained from a contact list, an address book, a customer relations management (CRM) application, or other source that is configured to store addresses.

The parcel information can also include a sender and/or return address, a parcel description, a parcel size, a content description (e.g., descriptive information regarding the contents of the parcel), parcel value, shipping preferences such as a preferred delivery time or preferred recipient, and any combinations thereof.

Generally speaking, the scanning of the scannable parcel tag allows the scanning party to add, change, log, write, or overwrite the parcel information stored in the database record. For example, the sender may add, change, or overwrite shipping information, while a postal carrier may scan the scannable parcel tag to log tracking information about the parcel to the server 105.

For example, the sender may specify if the parcel is a box or an envelope. The sender may specify a parcel weight or envelope size. In some embodiments the sender may request a delivery method such as first class, overnight, priority, ground, air, and/or other shipping preferences. According to some embodiments, the sender may also input information such as certification, signature requests, deliver time, and so forth.

If the sender has not previously established a payment option, the method may include the sender inputting 240 payment information. The payment information can include credit card information, checking account information, or other payment information that would be known to one of ordinary skill in the art. The payment information is stored in a payment profile that is separate from the database record associated with the scannable parcel tag.

FIG. 2C is a flow chart of a method executed by a parcel carrier, such as the United States Post Office, or a shipping and logistics company. The method may include the postal carrier receiving 245 the activated package with scannable parcel tag. Prior to shipping, the method may include the postal carrier verifying 250 the parcel information and parcel payment. Once payment has been verified the parcel with its scannable parcel tag is ready to ship.

For example, the sender may drop the parcel off for shipping at a recognized delivery location. Once the parcel is received by the postal carrier the scannable parcel tag of the parcel can be scanned by the postal carrier to determine the recipient address. In some embodiments, the postal carrier may check the weight and payment for the parcel to ensure that the sender correctly identified the parcel. If additional payment is needed the server 105 may transmit to the client 110 a message that additional payment is required before the parcel is shipped. The sender may approve the additional payment if desired. This additional payment can be facilitated using the payment information for the sender.

Alternatively, if the sender does not approve the additional payment or the payment account includes insufficient funds the parcel can be shipped back to the sender using sender information included in the database record.

If the recipient information and payment information are correct, the method may include shipping 255 the parcel to the recipient identified in the database record. Prior to shipping, the postal carrier may update the parcel information with additional information such as an estimated delivery date. This information is stored in the database record as tracking information. Indeed, in some instances, each time the scannable parcel tag is scanned during transit the database record can be updated with additional tracking information. This tracking information may include a time stamp and/or location stamp, as well as a postal carrier identifier or other postal carrier information.

As noted above, the verification of payment may include the postal carrier verifying that sender has sufficient funds to ship the parcel. In some instances, the postal carrier is not permitted to request payment until the recipient has actually received the parcel. Thus, the method may include the postal carrier receiving 260 payment for shipping the parcel only after the parcel has been delivered to the recipient.

When the parcel is received by the recipient, the recipient may reuse the parcel and scannable parcel tag by updating the parcel information stored in the database record. As with the sender, the recipient may establish a user profile and payment account prior to using the parcel with scannable parcel tag. The method can optionally include the recipient inputting updated parcel information for the scannable parcel tag from the recipient. The updated parcel information comprises at least shipping data that identifies a second recipient. Also, the recipient may overwrite the parcel information with the updated parcel information. The parcel is then ready to ship to the second recipient. This process can occur over and over, reusing the parcel and scannable parcel tag.

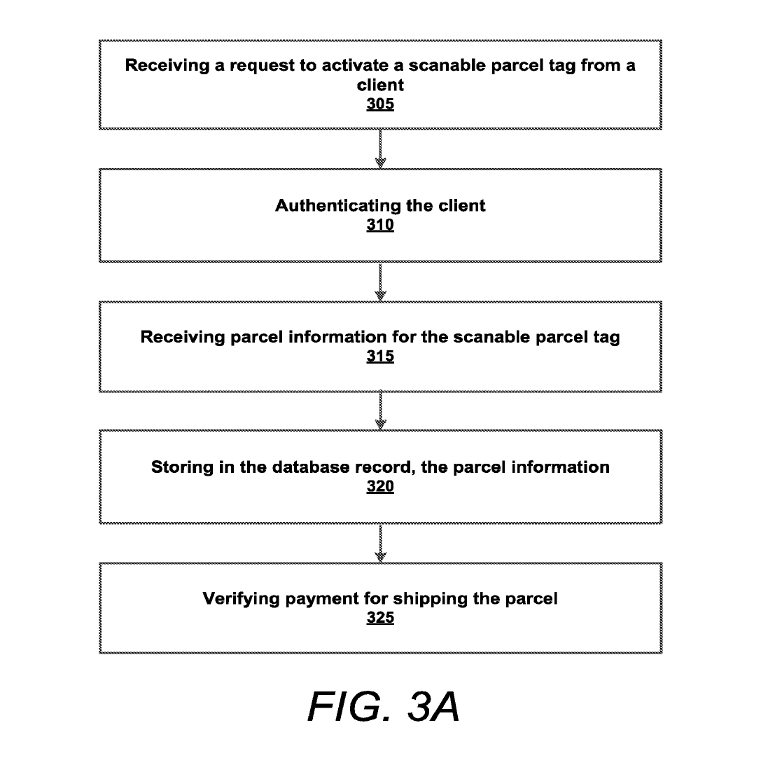

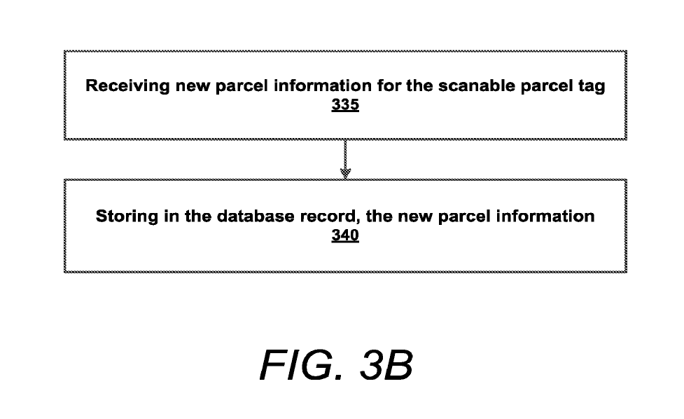

FIG. 3A is a flow chart of a parcel processing method executed by the server 105. The server 105 may be operated by a postal carrier who facilitates the delivery of parcels to recipients on behalf of senders. In other embodiments, the server 105 may be implemented, for example, within a company that provides internal mail delivery between employees.

The method may include receiving 305 a request to activate a scannable parcel tag from a client. As mentioned previously, the scannable parcel tag embeds a logical link to a database record. The method may include authenticating 310 the client and receiving 315 parcel information for the scannable parcel tag. Again, the parcel information comprises at least shipping data that is indicative of a recipient. Alternatively, the shipping data may comprise information indicative of a shipper and information indicative of a recipient.

The method also includes the server storing 320 in the database record, the parcel information. Prior to shipment, the method may include the server receiving or verifying 325 payment (also referred to as postage payment information) for the parcel. Once the parcel information and payment information have been verified, the method includes the server activating 330 the scannable parcel tag for use.

The parcel is then shipped to the recipient by the postal carrier.

It will be understood that in some instances steps 305-320 may be executed by a server 105 that is operated by a third party. The postal carrier may communicate with the third party when a parcel is dropped off by a customer. Thus, the postal carrier will scan the scannable parcel tag of the parcel and verify with the third party that the scannable parcel tag has been activated. If activate the postal carrier will ship the parcel to the recipient and then receive compensation when the package is delivered. Thus, senders are not required to pay for parcels that are mis-delivered or not delivered by the postal carrier, which is advantageous to the sender. Senders need to pre-pay for delivery of parcels and are not required to request compensation from the parcel carrier if the parcel is mis-delivered or not delivered.

After the parcel is received by the recipient, the recipient may scan the scannable parcel tag to obtain parcel information. Thus, the method includes the server 105 receiving from the recipient a request for parcel information. For example, the reader device (e.g., client) of the recipient is used to scan the scannable parcel tag. A reader application on the reader device is configured to extract the logical link and provide the same to the server 105. The request may also include request parameters that specify the type of parcel information that the recipient desires. For example, the recipient may request parameters such as parcel tracking history, sender address, postage amount, or other parcel information. The method may include the server 105 transmitting back to the recipient's reader device, the requested parcel information.

In some embodiments the server 105 may require the recipient to establish a recipient user profile before requesting and receiving parcel information. In these instances, the server 105 may authenticate the recipient before transmitting a response to the recipient.

FIG. 3B is a flow chart of a method for reusing the parcel with scannable parcel tag by the recipient of the method of FIG. 3A. If the recipient desires to reuse the parcel with scannable parcel tag, the method 105 includes the server 105 receiving 335 new parcel information for the scannable parcel tag. It will be understood that the new parcel information comprises at least shipping data and that the new parcel information is different from the parcel information that specified the recipient address. Thus, the shipping data of the new parcel information may include a second recipient address.

The method further includes the server 105 storing 340 in the database record, the new parcel information. In some instances, the storing of the new parcel information comprises overwriting the shipping data with updated shipping data without changing the scannable parcel tag on the parcel. That is, the scannable parcel tag is not changed itself and the logical link embedded in the scannable parcel tag remains the same inasmuch as the logical link will still specify a logical address or location of the database record associated with the scannable parcel tag. The overwriting of parcel information is all that is necessary to reuse the parcel and scannable parcel tag.

According to some embodiments, the server 105 may also be configured to allow for the association of a media file with the scannable parcel tag. For example, when a sender prepares to ship a parcel with a scannable parcel tag the sender may specify a media file, such as a video, audio, or image file that is associated with the scannable parcel tag. In accordance with the present disclosure the media file is stored (or a logical link or pointer to the media file) in the database record. When a recipient scans the scannable parcel tag, the media file is presented to the recipient. By way of non-limiting example, a recipient scans the scannable parcel tag with a reader device, such as a Smartphone that is configured to read the scannable parcel tag using a mobile parcel processing application. The scanning of the scannable parcel tag causes the mobile parcel processing application to extract the logical link to the database record. The server 105 will then return the media file to the mobile parcel processing application, which it turn, causes the media file to be displayed or stored on the recipient reader device. This method is advantageous for transparently providing to the recipient an advertisement. For example, the media file may include a video advertisement or a banner ad that is displayed to the recipient. When a sender chooses to deliver an advertisement media file along with their parcel, a partial subsidy for the cost of shipping the parcel may occur. That is, a third party advertiser may desire to pay for a portion of the postage required to ship the parcel if the sender is willing to allow an advertisement to be delivered along with a scanning of the scannable parcel tag when the parcel is received by the recipient.

In other embodiments, the parcel information can comprise various types of additional information such as assembly instructions, an electronic copy of content shipped in the parcel, and combinations thereof. For example, if the object that is shipped in the parcel requires assembly, the parcel information can include an assembly instructional video or electronic version of the assembly instructions, of which a physical copy is provided in the parcel. Thus, if the recipient loses the hard copy, the recipient can scan the scannable parcel tag and request from the server 105 an electronic copy of the assembly instructions.

The server 105 may also implement security features for a parcel such as the requiring of a digital signature. For example, sender may specify in the database record that an electronic signature is required for successful delivery of the parcel. Thus, the recipient and/or the postal carrier are required to use a reader device of the present technology. In one example, the postal carrier scans the parcel when delivering the parcel is delivered to the recipient. The server 105 returns a notice to the reader device of the postal carrier that a digital signature is required to complete parcel delivery. Thus, the recipient is required to also scan the scannable parcel tag as a digital signature. In some embodiments, the recipient reader device and the postal carrier reader device can exchange digital signature using near field communications. Upon authentication of the digital signature, the parcel is released to the recipient.

As mentioned above, the recipient may be required to maintain a recipient user profile. A digital signature may be stored in this profile or on the reader device of the recipient. Therefore, in some embodiments, a digital signature is applied with the recipient scans the scannable parcel tag. The digital signature application may be stored in the database record associated with the scannable parcel tag.

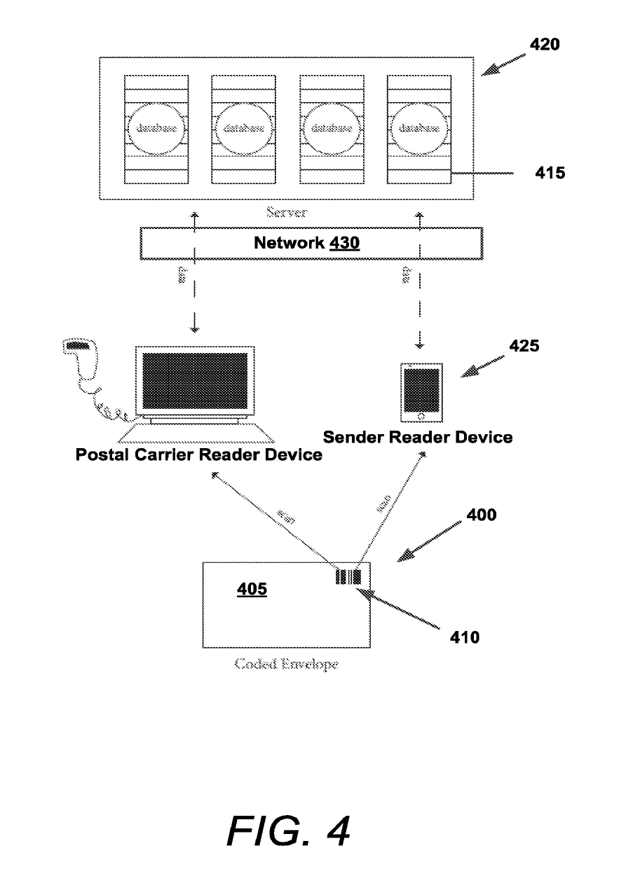

FIG. 4 is a perspective view of system that includes an example parcel. In this example, the parcel 400 comprises an enclosure 405 that is in the form of an envelope. It will be understood that the enclosure can include any type of parcel such as a box, a package, a shipping container, a postcard, and other parcel types that would be known to one of ordinary skill in the art.

The enclosure is 405 is provided with a scannable parcel tag 410 that is printed, affixed, or otherwise physically associated with the enclosure 405. Again, the scannable parcel tag 410 is illustrated as a bar code that is printed on the enclosure 405 in a location that is typical of a postage stamp. The scannable parcel tag 410 can be located on any area of the enclosure. The generation of the scannable parcel tag may occur during printing or manufacturing of the enclosure 405. In other examples, the scannable parcel tag can be printed and affixed to the enclosure similarly to a postage stamp. Thus, the parcel carrier or a third party may provide the scannable parcel tag to consumers who affix the scannable parcel tag to a parcel. The parcel carrier or third party may also create and maintain a database record for each scannable parcel tag. The party tasked with creating and maintaining database records for scannable parcel tags may choose to only create a database record when a scannable parcel tag has been scanned to prevent the creation of unnecessary database records.

A database record 415 is stored on a server 420. As mentioned previously, parcel information for the scannable parcel tag 410 is stored in the database record 415 that is accessible over a network 430.

Turning now to another example use case, the system of FIG. 4 is used to perform a method of parcel processing and tracking. A sender reader device (e.g., client) 425 scans the scannable parcel code 410 with a device capable of translating the code into a pre-embedded link, which in turn references the database record 415 for that code. Examples of reader devices include point-of-sale computer systems, Smartphones, and tablet computers.

The sender then inputs parcel information into their reader device and the server 420 associates that the parcel information with the database record of the scannable parcel tag.

Once a postal carrier receives the parcel, the now-customized scannable parcel code is scanned by a postal carrier reader device 430. The parcel information associated with the scannable postage code may now be accessed and reviewed at any time by scanning the scannable postage code. Delivery of the parcel is based on the scannable postage code's associated data. For example, the parcel information may include a recipient address. Thus, the parcel is shipped by the parcel carrier to the recipient address.

While the above examples contemplate the use of the present technology for delivering parcels by shipping or mail, it will be understood that the present technology may also likewise be applied to other enclosures such as suit cases or travel parcels. Airlines or cruise ships can conveniently scan, receive, and track customer luggage using these scannable parcel tags that are affixed to a customer's luggage. Rather than creating baggage tags, which can be damaged or removed during travel, the customer's flight information and return address can be stored on the scannable parcel tag that is affixed to, or printed directly on, the customer's luggage.

FIG. 5 illustrates an exemplary computing device 1 that may be used to implement an embodiment of the present systems and methods. The system 1 of FIG. 5 may be implemented in the contexts of the likes of the server 105 and reader devices described herein. The computing device 1 of FIG. 5 includes a processor 10 and main memory 20. Main memory 20 stores, in part, instructions and data for execution by processor 10. Main memory 20 may store the executable code when in operation. The system 1 of FIG. 5 further includes a mass storage device 30, portable storage device 40, output devices 50, user input devices 60, a display system 70, and peripherals 80.

The components shown in FIG. 5 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 5. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys, or a scanner for reading bar codes. Additionally, the system 1 as shown in FIG. 5 includes output devices 50. Suitable output devices include speakers, label and receipt printers, network interfaces, and monitors.

Display system 70 may include a liquid crystal display (LCD) or other suitable display device. Display system 70 receives textual and graphical information, and processes the information for output to the display device.

Peripherals 80 may include any type of computer support device to add additional functionality to the computing system. Peripherals 80 may include a modem or a router.

The components contained in the computing system 1 of FIG. 5 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

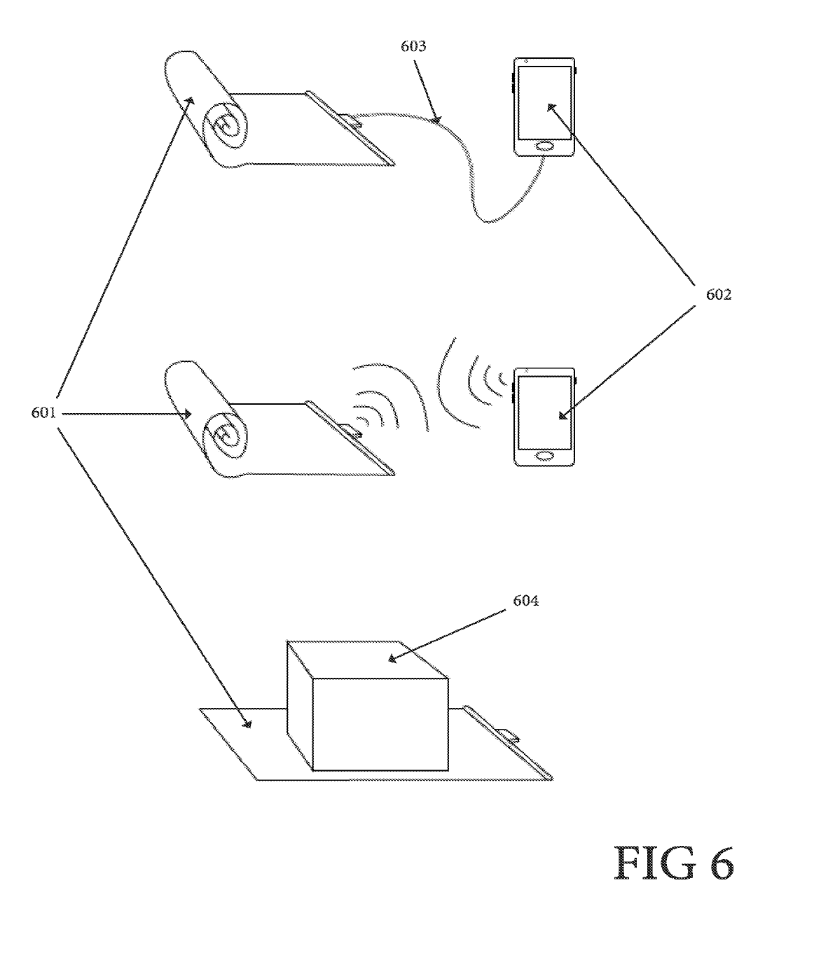

According to some embodiments, other input devices further enhance the user interface. Such devices assist in the measurement and weight of envelopes, boxes, and all types of parcel. By way of example, a mobile weight sensor pad is shown in FIG. 6 according to one embodiment. FIG. 6 illustrates flexible, mobile sensor pads 601 that are rolled and unrolled for weighing parcels according to some embodiments. In one embodiment, the mobile sensor pad is configured to be connectable to the smartphone by a wire 603 for power and/or data communication between the sensor pad 601 and smartphone 602. In another embodiment, the mobile sensor pad 601 is configured with a suitable wireless transmitter and/or transceiver for wirelessly connecting to the smartphone 602 for power and/or data communication therebetween. Devices of this nature are utilized for the purpose of communicating data to the computing device and the application to calculate accurate shipping information.

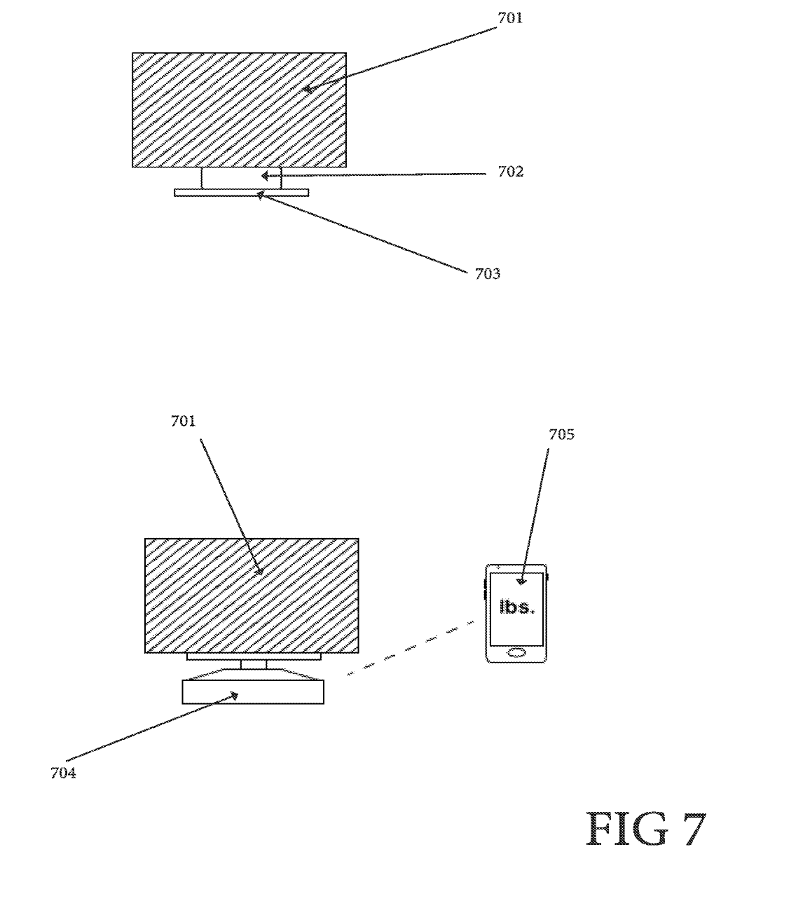

Other examples of input devices for weight measurement of parcels 701 are shown in FIG. 7. FIG. 7 illustrates a weight phone-sensor-block 702, according to another embodiment, which is either a block that rests upon the smartphone 703 that is configured to transform the phone into a scale. Alternatively, as shown in FIG. 7, the sensor block is an independent block 704 with its own sensors that is configured. FIG. 7 therefore indicates a sensor block according to some embodiments, which may be used independently or in conjunction with another weight-sensing mobile device to determine weight. Other examples of input devices for weight measurement include a fixed scale according to one embodiment. The fixed scale is a traditional scale with a smartphone registering the data from the scale according to one embodiment.

In some embodiments, the scale is configured to plug into the phone or stationary scanning device to calculate the weight. The scale can be a small plate or small roll out piece of mat-fabric configured to detect and calculate weight to the actual screen on the phone being the scale. It has built in pressure switches for writing code to over power and transforming into a scale for small objects or place a small piece block and plate atop the phone and act as an all in one scale using the technology already in the phone.

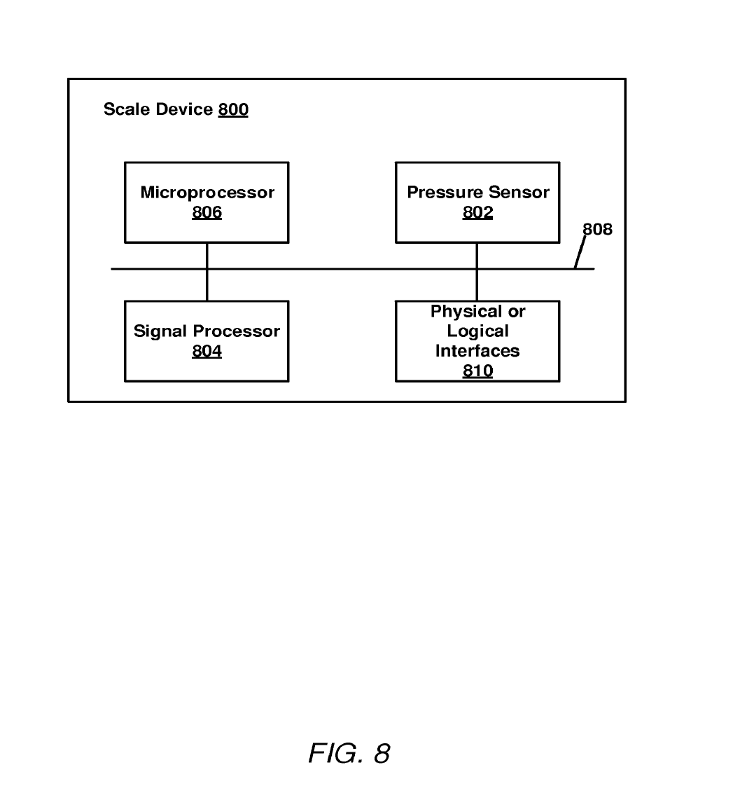

FIG. 8 is a schematic diagram that illustrates further details of such as scale, scale device 800, that can be utilized in accordance with the present technology. The scale device 800 can comprise a pressure sensor 802, a signal processor 804, and microprocessor 806. In one embodiment, the pressure sensor is a load cell transducer, such as a strain gauge load cell or a piezoelectric load cell. The microprocessor 806 can be coupled with the pressure sensor 802 and signal processor 804 using a bus 808. The scale device 800 can utilize other components of an electronic scale that would be known to one of ordinary skill in the art, as well as other components described with respect to the computing device of FIG. 5.

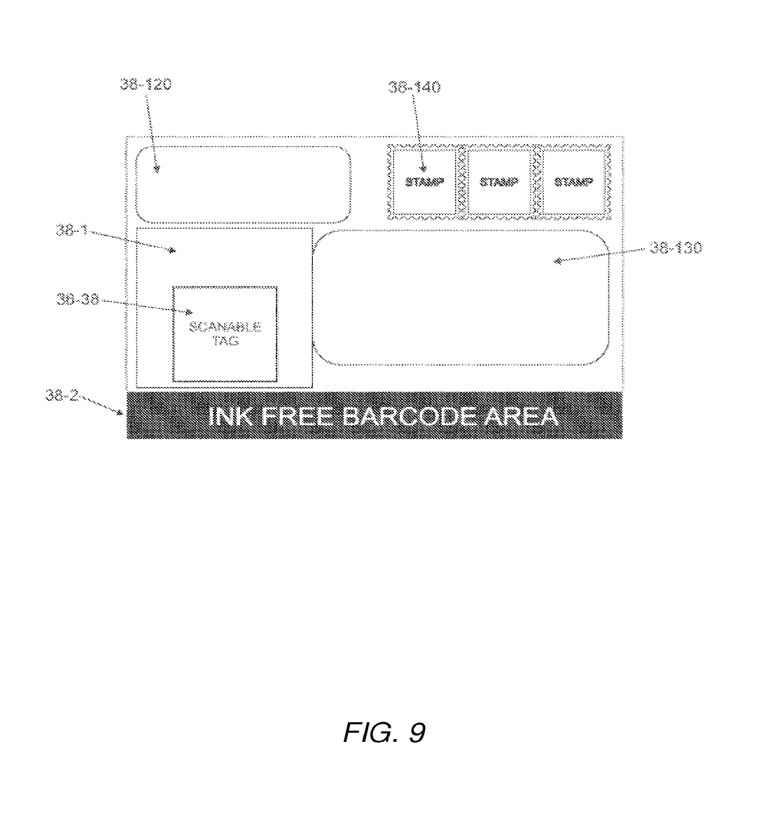

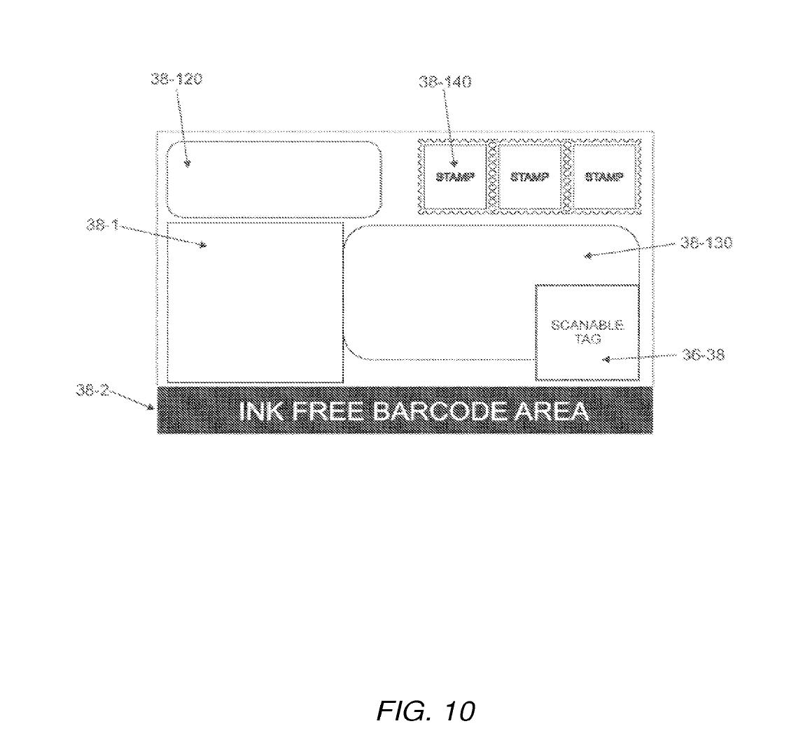

In some embodiments, the scale device 800 can communicate wirelessly (or in wired connection) with a mobile device such as the client 110 of FIG. 1 to transmit to the client 110 weight signals that correspond to the weight of an object placed on the scale device 800 such as a reusable package/parcel of the present technology. To be sure, an example reusable parcel is illustrated in FIGS. 9 and 10.

In some embodiments, the client 110 can couple with the scale device 800 over a USB port or other physical interface such as a serial port microSD port. Thus, the scale device 800 can comprise one or more physical or logical interfaces 810 that allow the scale device 800 to couple with the client 110 or other external computing device such as point of sale terminals and the like.

In operation, when a reusable package is placed into direct or indirect physical position with the pressure sensor 802, the pressure sensor 802 generates an analog signal that is indicative of the weight of the reusable package. The signal is received by the signal processor 804 and the signal processor 804 converts the weight signal into a digital signal for use by the microprocessor 806. In some embodiments, the microprocessor 806 is configured to format the weight signal into output that can be displayed on a display device or transmitted to the client 110 for display thereon.

In some embodiments, the scale device hardware of FIG. 8 is integrated within the mobile device itself.

FIG. 9 is a view of a reusable parcel panel indicating the areas of interest showing a non-limiting embodiment for the placement of any one of the scannable parcel tags of the embodiments described herein. The panel may be a back panel of a post card envelope. In other embodiments, the panel is front panel of an envelope having front and a rear planar panels which panels are adjacent each other with an open space therebetween. The open space sized to removably receive contents therein. The envelope has an opening into the open space, the opening including a resealable closure.

As illustrated in FIG. 9, the envelope panel has areas for address labels (38-120 and 38-130), postage (38-140), an area for a note, message or illustration (38-1), an area for official postal use/cancellation bar area (38-2), and an area for a scannable parcel tag area 36-38. In alternative embodiments, the envelope includes one or any combination of the aforesaid areas. In yet other embodiments, the scannable parcel tag contains all necessary mailing information such as but not limited to proof of payment, sender info, recipient info, tracking, and more and may be the only marking on the box/envelope.

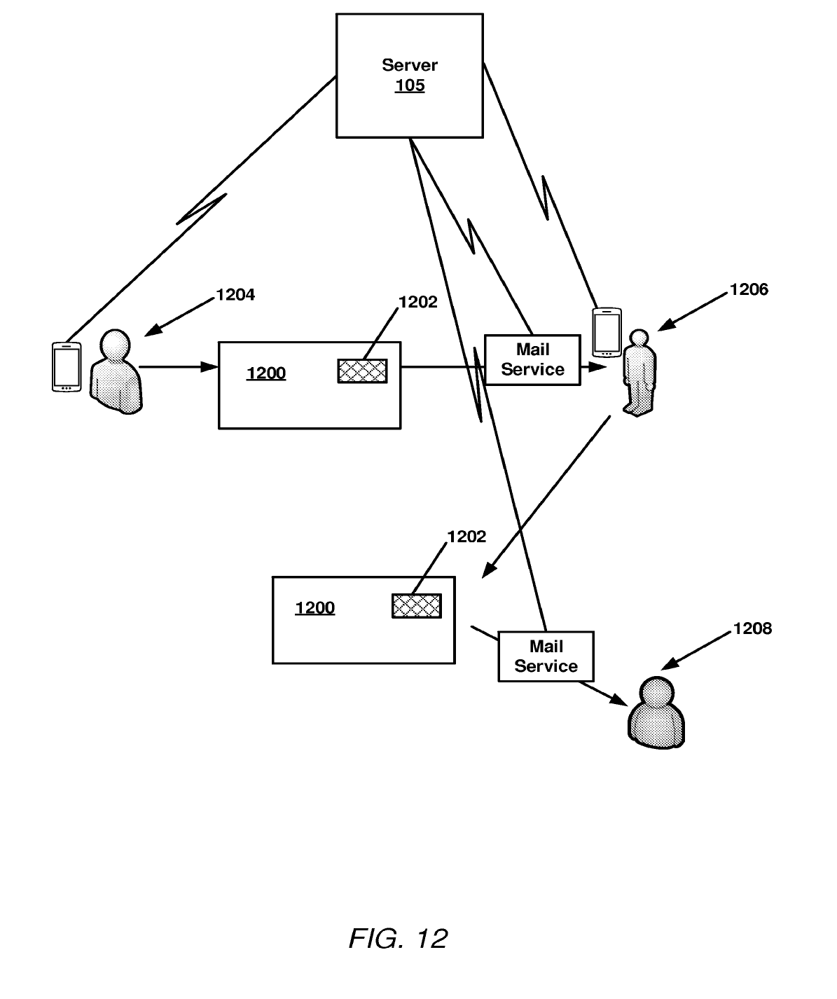

In some embodiments, these one or more surface areas or regions are formed of a material that is configured to releasably hold label(s) thereon. The or each surface region releasably holds an adhesively backed structure, such as the address label, thereon located on the panel and in a manner allowing the adhesively backed structure to be removed and a new adhesively backed structure to be applied. In this manner, the reusable envelope or post card with the scannable parcel tag can be reused by a recipient of the reusable envelope or other type parcel by the recipient removing the original address label and/or other label(s) from the surface region, then applying a new address label and/or other label(s) and by the recipient overwriting the original shipping information associated with the scannable parcel tag with new shipping information. In some embodiments, this new shipping information includes shipping information corresponding at least in part to shipping information, such as the new recipient address, that is printed or otherwise applied to the new applied adhesive backed structures (such as the address label and/or other label). Further details of the process of a first user (sender) sending such reusable envelopes, or other parcel, having a reusable scannable tag, to a second user also referred to as a recipient are shown and described in more detail below with reference to FIG. 12.

In one embodiment, the parcel panel, such as the parcel panel of FIG. 9, includes a plurality of the adhesively backed structures to be selectively removed and new adhesively backed structures to be selectively applied. The adhesively backed structures may comprise postage, address labels, or return address labels, or any combination thereof.

In some embodiments, the scannable parcel tag can be subsequently hidden by the labels, postage, notes, or other coverings, such that the scannable parcel tag 36-38 is at least partially covered so that the scannable parcel tag is not easily readable until the sender/recipient intends to view the mailing data associated with the scannable parcel tag. For added privacy, the scannable parcel tag may also be password protected. In some embodiments, an ink free barcode area is provided which extends laterally along a bottom region of the envelope. In yet other embodiments, in addition to the mailing data (shipping and other information associated with the mailing of the parcel) being associated with the scannable parcel tag, greeting media/multimedia file data is also associated with the scannable parcel tag for example by a sender uploading greeting data in addition to the shipping information etc.

FIG. 10 is a view of a resusable envelope panel non-limiting embodiment for the placement of the scannable parcel tag area 36-38. To be sure, the reusable envelope technology can be extended to any package or parcel type. Additional details regarding a reusable parcel can be found in U.S. Pat. No. 8,870,061, issued Oct. 28, 2014, which is incorporated by reference herein in its entirety, including all references cited therein, and/or in U.S. patent application Ser. No. 14/491,850, filed Sep. 19, 2014, which is incorporated by reference herein in its entirety, including all references cited therein.

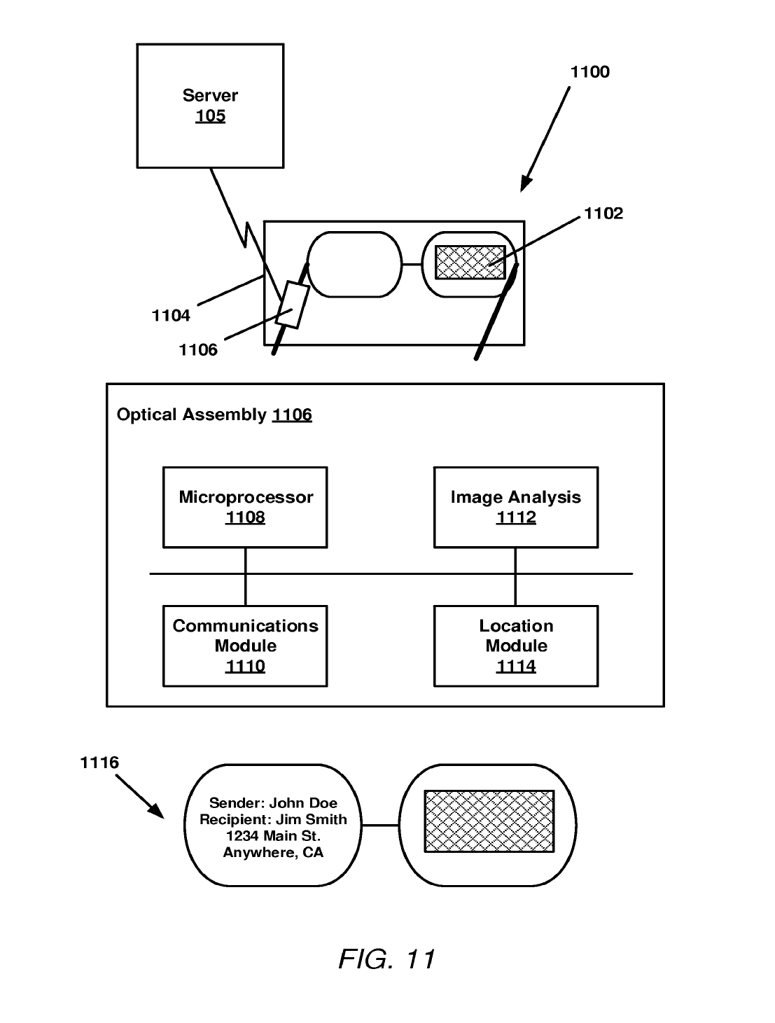

FIG. 11 is a schematic diagram of an example wearable device 1100 that is configured to capture images of a scannable parcel tag 1102 associated with a reusable parcel 1104. The wearable device 1100 includes a pair of eyeglasses that are equipped with optical analysis features, which are provided by an optical assembly 1106.

In some embodiments, the optical assembly 1106 comprises a microprocessor 1108, a communications module 1110, an image analysis module 112, and a location module 114. To be sure, the optical assembly 1106 can include additional or fewer components than those illustrated in FIG. 11.

The wearer of the wearable device 1100 looks at the scannable parcel tag 1102 associated with the reusable parcel 1104. The microprocessor 1108 of the optical assembly 1106 can be configured to capture images viewed through the optics of the wearable device 1100. As images are captured, the image analysis module 1112 performs image processing methodologies on the objects located in the captured image. The image analysis module 1112 can be configured to recognize the scannable parcel tag 1102, either in general as a scannable parcel tag or directly as a particular scannable parcel tag assigned to a sender and/or recipient.

In some embodiments, the image analysis module 1112 can be configured to recognize that an image includes a scannable parcel tag and can transmit the image to the server 105 for further analysis. The server 105 can search the scannable parcel tag for any requested information and return the same to the wearable device 1100 for display thereon, as illustrated as message 1116. In one embodiment, the wearable device is a head mounted display including an optical assembly that is configured to merge real background images of the reusable envelope and parcel tag being scanned and virtual images of the retrieved information associated with the scanned parcel tag.

According to some embodiments, the microprocessor 1108 is configured to attach a timestamp and/or location to an image captured of the scannable parcel tag 1102. For example, the microprocessor 1108 can use a GPS signal produced by the location module 1114 and attach the same to a message transmitted to the server 105. The message can include the image captured by the wearable device 1100 along with the GPS location information, or alternatively just the GPS location information with an indication of the specific scannable parcel tag that was located in the view captured by the wearable device 1100.

Thus, each time a wearable device that is capable of reading scannable parcel tags of the present technology actually identifies a scannable parcel tag, the GPS location of the parcel associated with the scannable parcel tag is identified and stored by the server 105. This process provides noted advantages over current methods that depend on user scanning of tracking codes on parcels during transit. Automating location capturing of parcels avoids gaps in location information and greatly improves parcel tracking processes.

In one example method, the server 105 can cooperate with the wearable device 1100 to update tracking information for a parcel. The method can include receiving an image from a wearable device. As mentioned above, the image comprises a view of a scannable parcel tag.

Next, the method includes the server 105 identifying the scannable parcel tag in the image. Any number of image processing technologies can be utilized to determine the presence of a scannable tag in the image.

The server can then locate one or more users associated with the scannable parcel tag and store location information for the wearable device in association with the scannable parcel tag.

In some embodiments, the method includes the server updating tracking information for a parcel associated with the scannable parcel tag using the location information.

Additionally, the present technology can allow a sender or recipient to further track and manage the logistics for a parcel by providing for en-route changes to the shipping information on the fly. For example, if the recipient will not be home during delivery, the shipping information can be used to update the recipient information to a location where the recipient will actually be present.

As tracking information changes en-route, such as when the scannable parcel tag is scanned (either by image capturing or scanning), the tracking information can be transmitted to the client or sender/recipient parties for immediate updating.

In some embodiments, the present technology can allow for digital signatures or restricted delivery methods.

FIG. 12 illustrates a process whereby a first user (first sender) 1204 sends a parcel 1200 with a reusable scannable parcel tag 1202 to a second user 1206 also referred to as a recipient (second sender) 1206.

In some embodiments, the reusable parcel can be a reusable envelope or postcard described herein. The scannable parcel tag can be anyone of the parcel tags described herein. The first user 1204 can send the parcel 1200 through any suitable mail service. To be sure, the first user 1204 can scan the scannable parcel tag 1202 and define necessary information that will allow the mail service to deliver the parcel 1200 to the second user 1206, such as a shipping address. This information is transmitted to the server 105.

After receiving the parcel 1200 the second user can act as a second sender by scanning the scannable parcel tag 1202 and overwriting the recipient information stored for the scannable parcel tag 1202. Advantageously, the parcel 1200 is the exact same parcel that was transmitted to the second user 1206. Also, the scannable parcel tag 1202 is unchanged on the parcel 1200, while the mailing information associated with the scannable parcel tag 1202 is changed on the server 105. This allows the parcel 1200 to be completely reused. Thus, the second user 1206 can mail the same parcel 1200 to a third user (second recipient) 1208. The only required process is the scanning of the scannable parcel tag 1202 by the second user 1206, the updating of the sender and/or recipient information by the second user 1206, and the subsequent mailing of the parcel 1200 to the third user 1208.

To be sure, each of the mail services illustrated will have the capability of scanning the scannable parcel tag 1202 and receiving sender/recipient information stored in the scannable parcel tag 1202 in order to correctly deliver the parcel to an intended recipient.

In one embodiment, the client 110 can be used to capture images of the parcel associated with a scannable parcel tag as evidence that can be used to support an insurance claim or reimbursement. Users can be required to obtain an image of the parcel both before mailing and after receipt by the recipient. The server 110 can require photographs of the parcel before allowing the sender to upload their shipping information. Likewise, the server 110 can restrict delivery of the parcel by requiring the recipient to upload a photo of the parcel prior to release of the parcel by the mail service.

In some embodiments, the first user 1204 and/or second user 1206 scans the parcel tag and defines necessary information by means of wearable devices such as by using the wearable devices and methods of operation of those devices according to embodiments described herein.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, PHP, MySQL, HTML, Java Script, CSS, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

What is claimed is:

1. A method executed by a parcel processing system that comprises a processor and a memory for storing executable instructions, the instructions being executed by the processor to perform the method, comprising:
receiving a request to activate a scannable parcel tag, the scannable parcel tag embedding a logical link to a database record;
receiving parcel information for the scannable parcel tag, the parcel information comprising at least shipping data; and
storing in the database record, the parcel information.

2. The method according to claim 1, wherein the shipping data comprises at least one of information indicative of a shipper and information indicative of a recipient.

3. The method according to claim 1, further comprising:
receiving new parcel information for the scannable parcel tag, the new parcel information comprising at least shipping data, the new parcel information being different from the parcel information;
storing in the database record, the new parcel information.

4. The method according to claim 1, further comprising:
receiving message that the scannable parcel tag has been scanned; and
transmitting to a requester the parcel information.

5. The method according to claim 1, further comprising:
receiving postage payment information for the scannable parcel tag; and
activating the scannable parcel tag for use.

6. The method according to claim 1, further comprising generating the scannable parcel tag.

7. The method according to claim 6, further comprising applying the scannable parcel tag to a parcel.

8. The method according to claim 1, further comprising overwriting the at least shipping data with updated shipping data without changing the scannable parcel tag on the parcel.

9. The method according to claim 1, further comprising;
associating a media file with the scannable parcel tag;
receiving message that the scannable parcel tag has been scanned; and
providing the media file to a requester.

10. The method according to claim 1, further comprising overwriting the at least shipping data with updated shipping data.

11. A parcel processing system, comprising:
means for receiving a request to activate a scannable parcel tag, the scannable parcel tag embedding a logical link to a database record;
means for receiving parcel information for the scannable parcel tag, the parcel information comprising at least shipping data; and
means for storing in the database record, the parcel information.

12. The parcel processing system according to claim 11, further comprising:
means for receiving postage payment information for the scannable parcel tag; and
means for activating the scannable parcel tag for use.

13. A parcel processing system, comprising:
a processor; and
a memory for storing executable instructions, the instructions being executed by the processor to:
receive from a sender a request to activate a scannable parcel tag that has been applied to a parcel, the scannable parcel tag embedding a logical link to a database record;
receive parcel information for the scannable parcel tag, the parcel information comprising at least shipping data that identifies a recipient; and
store in the database record, the parcel information.

14. The parcel processing system according to claim 13, wherein the processor further executes the instructions to store parcel information with the database record, the parcel information comprising any of assembly instructions, an electronic copy of content shipped in the parcel, and combinations thereof.

15. The parcel processing system according to claim 14, wherein the processor further executes the instructions to lock the electronic copy of content shipped in the parcel; and unlock the electronic copy of content shipped in the parcel when the scannable parcel tag is scanned by the recipient identified in the database record.

16. The parcel processing system according to claim 13, wherein the processor further executes the instructions to receive a digital signature for the parcel, the digital signature being applied by the recipient when scanning the scannable parcel tag.

17. The parcel processing system according to claim 13, wherein the processor further executes the instructions to allow a sender to add, change, log, write, or overwrite the parcel information stored in the database record by scanning the scannable parcel tag.

18. The parcel processing system according to claim 13, wherein the processor further executes the instructions to receive tracking information for the parcel each time the scannable parcel tag is scanned; and storing the tracking information in the database record.

19. The parcel processing system according to claim 13, wherein the processor further executes the instructions to:
receive updated parcel information for the scannable parcel tag from the recipient, the updated parcel information comprising at least shipping data that identifies a second recipient; and
overwrite the parcel information with the updated parcel information.

20. A method, comprising:
receiving an image from a wearable device, the image comprising a view of a scannable parcel tag;
identifying the scannable parcel tag in the image;
locating one or more users associated with the scannable parcel tag;
storing location information for the wearable device in association with the scannable parcel tag; and
updating tracking information for a parcel associated with the scannable parcel tag using the location information.
